(19) United States
(12) Patent Application Publication
(10) Pub. No.: US 2016/0370866 A1
(43) Pub. Date: Dec. 22, 2016

(54) Method, System and Non-Transitory Computer-Readable Recording Medium for Automatically Performing an Action

(71) Applicant: Futureplay, Inc., Seoul (KR)

(72) Inventors: Sungjae Hwang, Seoul (KR); Jongho Kim, Seoul (KR)

(21) Appl. No.: 15/092,791

(22) Filed: Apr. 7, 2016

(30) Foreign Application Priority Data
Jun. 22, 2015 (KR) PCT/KR2015/006297

(51) Int. Cl. G06F 3/01; G06F 3/041; G06K 9/00

(52) U.S. Cl. CPC G06F 3/017; G06K 9/00335; G06K 9/00892; G06F 3/041

(57) ABSTRACT

A computer implemented method for automatically performing an action in a mobile device. The method includes recognizing, by a gesture unit, a gesture performed by a user on an object displayed on the mobile device. Further, the method includes recognizing, by a biometric unit, a biometric information based on the gesture. The method also includes determining, by a command unit, a command corresponding to the gesture and the biometric information. The method further includes performing, by a control unit, an action on the object based on the command.

### CROSS-REFERENCE TO RELATED APPLICATIONS

This application is a continuation-in-part of PCT Application No. PCT/KR2015/006297, filed Jun. 22, 2015, which claims priority to Korea Application Nos. KR10-2014-2014-0075331, filed Jun. 20, 2014, and KR10-2014-0153954, filed Nov. 6, 2014, the contents of which are incorporated by reference.

### TECHNICAL FIELD

The present invention relates to a portable electronic device for data transfer. More particularly, related to a mechanism for exchanging sensor data between a garment provided with a conductive thread and one or more external devices electromagnetically connected to the garment.

### BACKGROUND

Generally, as mobile devices such as a smart phone frequently receives information from various information sources, a demand for providing security to the mobile devices are increased.

With regard to this, various conventional mechanisms are proposed to provide security to the mobile devices. In one mechanism, techniques of the related art, a fingerprint of a user using a radio frequency (RF) in a predetermined region is recognized. In another mechanism, a shape of the fingerprint is recognized using an optical device such as an RGB camera. However, the conventional mechanisms are used, more particularly, for recognizing biometric information such as the fingerprint on the mobile device, but do not provide options to assist the user for controlling the mobile devices based on the recognized biometric information.

Thus, there remain a need of a robust and simple mechanism for recognizing the biometric information and providing options to assist the user for controlling the mobile devices.

### SUMMARY OF INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Accordingly the embodiment herein provides a mobile device for automatically performing an action. The mobile device includes a gesture unit configured to recognize a gesture performed by a user on an object displayed on the mobile device. Further, the mobile device includes a biometric unit configured to recognize a biometric information based on the gesture. Further, the mobile device includes a command unit configured to determine a command corresponding to the gesture and the biometric information. Further, the mobile device includes a control unit configured to perform an action on the object based on the command.

In an embodiment, the gesture is at least one of a single-touch gesture, a multi-touch gesture, a posture gesture, a motion gesture, and a hover gesture.

In an embodiment, the biometric information is at least one of fingerprint information, vein information, iris information, voice information, pulse information, brain wave information, and temperature information.

In an embodiment, the action includes at least one of trigger a payment with a credit card, store content in a storage space, import content, send content, delete content, share content, open an application, close an application, lock an application, modify an access level, and modify a security level.

In an embodiment, the action is performed based on a right empowered to a user.

In an embodiment, the command, corresponding to the biometric information, is predefined and stored in the mobile device.

In an embodiment, the command, corresponding to the biometric information, is dynamically defined based on the gesture.

In an embodiment, the user is identified based on the biometric information.

In an embodiment, the object corresponds to a graphical element displayed on the mobile device, wherein the gesture recognition unit activates a gesture recognition function in the graphical element.

Accordingly the embodiment herein provides a computer implemented method for automatically performing an action in a mobile device. The method includes recognizing, by a gesture unit, a gesture performed by a user on an object displayed on the mobile device. Further, the method includes recognizing, by a biometric unit, a biometric information based on the gesture. Further, the method includes determining, by a command unit, a command corresponding to the gesture and the biometric information. Further, the method includes performing, by a control unit, an action on the object based on the command.

Accordingly the embodiment herein provides a computer program product comprising a computer executable program code recorded on a computer readable non-transitory storage medium. The computer executable program code when executed causing the actions recognizing, by a gesture unit, a gesture performed on an object displayed on a mobile device. Further, the computer executable program code when executed causing the actions including recognizing, by a biometric unit, a biometric information based on the gesture. Further, the computer executable program code when executed causing the actions including determining, by a command unit, a command corresponding to the gesture and the biometric information. Further, the computer executable program code when executed causing the actions including performing, by the command unit, an action on the object based on the command.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

This invention is illustrated in the accompanying drawings, throughout which like reference letters indicate corresponding parts in the various figures. The embodiments herein will be better understood from the following description with reference to the drawings, in which:

FIG. 1 is a block illustrating high level overview of a mobile device to provide a user interface for performing various actions, according to an embodiment as disclosed herein;

FIGS. 2 to 4 are illustrations illustrating example scenarios in which a user interface is operated, according to an embodiment as disclosed herein;

FIG. 5 shows example illustrations illustrating a process of providing a visual feedback, according to an embodiment as disclosed herein;

FIG. 6 shows example illustrations illustrating operations of a user interface, according to an embodiment as disclosed herein;

FIG. 7 shows example illustrations illustrating a configuration which provides a user interface using an integrated technical unit, according to an embodiment as disclosed herein;

FIG. 8 is shows example illustrations illustrating a configuration in which various commands are performed in accordance with various gestures, according to an embodiment as disclosed herein;

FIGS. 9 to 11 shows example illustrations illustrating a payment process using a mobile device, according to an embodiment as disclosed herein;

FIGS. 12 and 13 shows example illustrations of a multi-modal security system which utilizes a gesture and fingerprint recognition, according to an embodiment as disclosed herein;

FIGS. 14 and 15 illustrate a mobile device which is implemented in a display with a camera function, according to an embodiment as disclosed herein;

FIG. 16 shows an example illustration illustrating detection of a gesture performed by a user without directly touching, according to an embodiment as disclosed herein;

FIGS. 17 and 18 show example illustrations illustrating another display with a camera function implemented by a Head Mounted Display (HMD), according to an embodiment as disclosed herein; and

FIGS. 19 and 20 show example illustrations illustrating yet another display with a camera function, according to an embodiment as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

A principle object of the embodiments herein is to provide a mechanism for recognizing a gesture and biometric information of a user and providing an option to assist the user for controlling the mobile devices.

Another object of the embodiments herein is to provide a mechanism for causing to display a convenient and extended user interface based on recognized gesture and biometric information of the user.

The embodiment herein provides a mobile device for automatically performing an action. The mobile device includes a gesture unit configured to recognize a gesture performed by a user on an object displayed on the mobile device. Further, the mobile device includes a biometric unit configured to recognize biometric information based on the gesture. Further, the mobile device includes a command unit configured to determine a command corresponding to the gesture and the biometric information. Further, the mobile device includes a control unit configured to perform an action on the object based on the command.

Another embodiment herein provides a computer implemented method for automatically performing the action in the mobile device. The method includes recognizing, by the gesture unit, the gesture performed by the user on the object displayed on the mobile device. Further, the method includes recognizing, by the biometric unit, the biometric information based on the gesture. Further, the method includes determining, by the command unit, the command corresponding to the gesture and the biometric information. Further, the method includes performing, by the control unit, the action on the object based on the command.

Unlike the conventional mechanisms, both the gesture and biometric information are recognized to provide a convenient and extended user interface to a user. According to the present invention, in addition to confirmation of an identity of a user, a gesture and biometric information are recognized and utilized to allow a mobile device to perform various actions. Further, according to the present invention, when the user simply inputs only the gesture or the biometric information, a corresponding command is performed on the corresponding object or graphical element on which the gesture is performed.

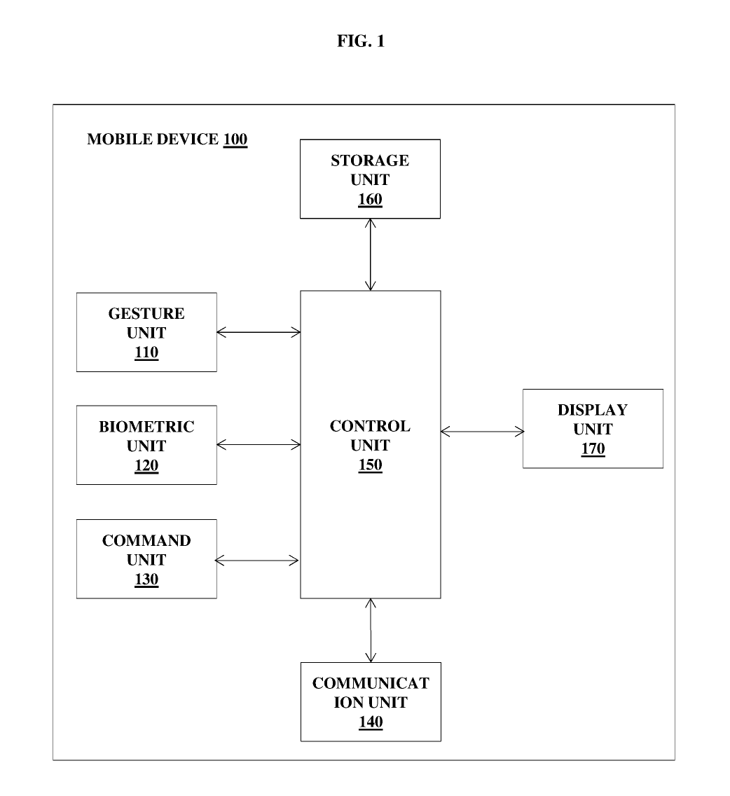

Referring now to the drawings and more particularly to FIGS. 1 to 20 where similar reference characters denote corresponding features consistently throughout the figures, there are shown preferred embodiments.

Throughout the description the term “object” and “graphical element” are used interchangeably.

FIG. 1 is a block illustrating high level overview of a mobile device 100 to provide a user interface for performing various actions, according to an embodiment as disclosed herein. The mobile device 100 described herein can be for example, but is not limited to, a personal computer (for example, a desktop computer or a notebook computer), a server, a workstation, a personal digital assistance, a web pad, a mobile phone, a smart phone, a tablet, a phablet, a communicator, a consumer electronic device, or any the device having memory unit and a microprocessor or a microcontroller configured to recognize biometric information and provide options to assist a user for controlling the mobile devices.

In an embodiment, the mobile device 100 includes a gesture unit 110, a biometric unit 120, a command unit 130, a communication unit 140, a control unit 150, a storage unit 160, and a display unit 170.

The gesture unit 110 is configured to recognize a gesture performed on an object displayed on the mobile device 100. The object described herein can be, for example, but is not limited to, an application icon, a symbol, a mark, or any graphical element. The gesture unit 110 performs a function which recognizes the gesture input from a user with reference to user manipulation input from a predetermined gesture input unit. The gesture according to the present invention may correspond to at least one object or command. In an embodiment, the gesture described herein can be at least one of a single-touch gesture, a multi-touch gesture, a posture gesture, a motion gesture, and a hover gesture.

For example, a gesture which is input from the user includes a touch input on an arbitrary point on a touch screen. The touch input can be a swipe operation or a drag operation performed to connect a first point with a second point on the touch screen, release after touch, flick, pinch, or the like. In another example, the gesture includes rotating or shaking the mobile device 100. In an embodiment, the gesture unit 110 configured to recognize the gesture by receiving information from various components such as the touch screen, an infrared sensor, an acceleration sensor, a camera, or the like. However, it is to be noted that the gesture according to the present invention is not limited to the above-mentioned items but may be changed without departing from the scope of the invention.

Further, the biometric unit 120 performs a function which recognizes biometric information input from a predetermined biometric information input unit. The biometric information according to the present invention may correspond to at least one object or command. In an embodiment, the biometric information may be at least one of fingerprint information, vein information, iris information, voice information, pulse information, brain wave information, and temperature information. Further the biometric information may be physiological information about blood pressure, heart rate, pulse, body temperature, foot speed and/or impact, walking speed, eye movements, sweat rate, frequency of swallowing, respiratory frequency, voice communications, water consumption and blood oxygenation.

In an embodiment, the biometric unit 120 configured to recognize the biometric information by receiving information from various components such as a fingerprint sensor, an iris sensor, a voice sensor, a pulse sensor, a brain wave sensor, or a temperature sensor, and also includes a display unit 170 which displays visual information accompanied with the user interface.

For example, the biometric information input from the user includes fingerprint information obtained from the fingerprint sensor, iris information obtained from the iris sensor, vein information obtained from the vein sensor, voice information obtained from the voice sensor, pulse information obtained from a pulse sensor, brain wave information obtained from the brain wave sensor, and temperature information obtained from the temperature sensor. However, it is to be noted that the biometric information according to the present invention is not limited to the above-mentioned biometric information but may be changed without departing from the scope of the invention.

In an embodiment, the gesture and the biometric information can be recognized sequentially, simultaneously, or substantially at the same time. For example, the biometric information is recognized after recognizing the gesture or the gesture is recognized after recognizing the biometric information.

In an embodiment, when the gesture unit 110 and the biometric unit 120 are configured to be integrated, the gesture and the biometric information may be input altogether.

For example, the gesture is input through the touch screen and the biometric information is input through the fingerprint sensor which is provided on a home button which is separately configured from the touch screen.

In another example, both the gesture and the biometric information may be input through an integrated technical unit such as a fingerprint on display or a trace fingerprint sensor.

Further, the command unit 130 determines a command corresponding to the recognized gesture or the recognized biometric information. In an embodiment, the command corresponding to the biometric information is predefined and stored in the mobile device 100. In an embodiment, the command, corresponding to the biometric information, is predefined and stored in the mobile device 100. In an embodiment, the command, corresponding to the biometric information, is dynamically defined based on the gesture.

For example, with reference to correspondence between a predetermined gesture and a predefined biometric information, a corresponding predetermined command is determined. Various gestures which are input from the user may be set in advance in order to correspond to the object or the command. Further, the object or the command which corresponds to the gesture which is input from the user may be specified by referring to the predetermined correspondence. For example, the gesture which touches any one icon of a plurality of icons displayed on the touch screen may be set in advance to correspond to selecting an object indicated by the icon. In another example, the gesture (that is, swipe or drag) which continuously touches one arbitrary point on the touch screen to another point may be set in advance to correspond to a command to store or import.

Basically, according to an example embodiment of the present invention, biometric information which is input from the user may be utilized as a criterion to confirm an identity of the user. Various biometric information which is input from the user may be set in advance in order to identify the command corresponding to the biometric information and the gesture. For example, the fingerprint information corresponding to an index finger is set in advance to correspond to an object A or command A and the fingerprint information corresponding to a thumb is set in advance to correspond to an object B or a command B. In another example, the fingerprint information corresponding to the index finger is set in advance to correspond to a command which makes a payment with a credit card A and the fingerprint information corresponding to the thumb is set in advance to correspond to a command which makes a payment with a credit card B.

Further, the command unit 130 performs a function which determines to execute a specified command on a specified object within a right empowered to the specified user. The control unit 150 is configured to perform at least one action based on the command. In an embodiment, the action described herein can include at least one of trigger a payment with a credit card, store content in a storage space, import content, send content, delete content, share content, open an application, close an application, lock an application, modify an access level, modify a security level, or the like.

Furthermore, the communication unit 140 is configured to perform a function which allows the mobile device 100 to communicate internally and externally among the units or devices.

Further, the storage unit 160 can encompass one or more memory devices of any of a variety of forms (e.g., read-only memory, random access memory, static random access memory, dynamic random access memory, or the like) and can be used by the control unit 150 to store and retrieve data. The data that is stored by the storage unit 160 can include operating systems, applications, and informational data. Each operating system includes executable code that controls basic functions of the mobile device 100, such as interaction among the various internal components, communication with external devices via the wireless transceivers or the component interface, and storage and retrieval of applications and data to or from the storage unit 160.

The storage unit 160 may include one or more computer-readable storage media. The storage unit 160 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the storage unit 160 may, in some examples, be considered a non-transitory storage medium. The term “non-transitory” may indicate that the storage medium is not embodied in a carrier wave or a propagated signal. However, the term “non-transitory” should not be interpreted that the storage unit 160 is non-movable. In some examples, the storage unit 160 can be configured to store larger amounts of information than the memory. In certain examples, a non-transitory storage medium may store data that can, over time, change (e.g., in Random Access Memory (RAM) or cache).

The display unit 170 can be configured to display a user interfaces to assist the user for controlling the mobile device 100. Unlike the conventional mechanism, a convenient and extended user interface is provide based on recognized gesture and the biometric information of the user to perform various actions in the mobile device 100. The display unit 170 is configured to sufficient interfaces to adaptively display the objects, graphical elements, content information or the like to perform various actions in the mobile device 100.

Further, the control unit 150 is configured to perform various functions which controls flow of data among the gesture unit 110, the biometric unit 120, the command unit 130, the communication unit 140, the storage unit 160, and the display unit 170. The control unit 150 controls the flow of the data from the outside or between components of the mobile device 100 to control the gesture unit 110, the biometric information unit 120, the command unit 130, the communication unit 140, the storage unit 160, and display unit 170 to perform their unique functions.

The FIG. 1 shows a limited overview of the mobile device 100 but it is to be understood that other embodiments are not limited thereon. Further, the mobile device 100 can include different units communicating among each other along with other hardware or software components. By way of illustration, both an application running in a mobile device and the mobile device can be the component. The label or name provided to each of the units is only for illustrative purpose and does not limit the scope of the invention. The one or more units can be combined or separated to perform the similar or substantially similar functionalities without departing from the scope of the invention. Further, the mobile device 100 can include any number of units communicating locally or remotely with one or more components for recognizing the biometric information and the gesture, and providing options to assist a user for controlling the mobile device 100.

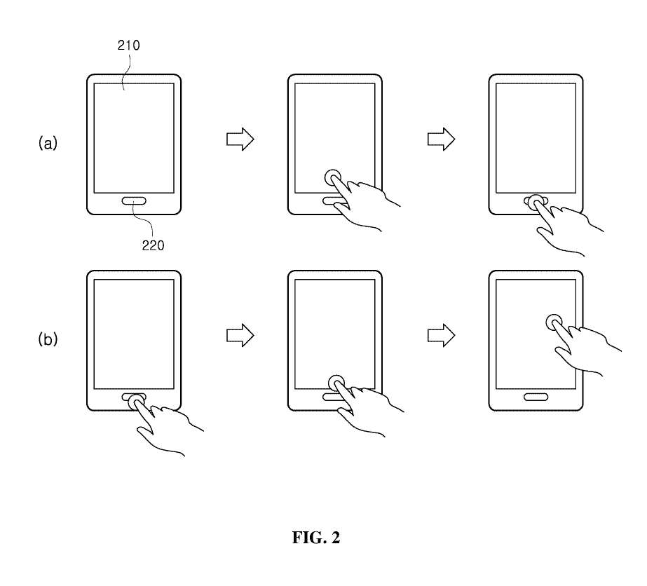

FIGS. 2 to 4 are illustrations illustrating example scenarios in which the user interface is operated, according to an embodiment as disclosed herein.

Referring to FIG. 2A, when a user A makes a drag gesture which drags content A towards a fingerprint sensor 220 of the mobile device 100 while touching the content A displayed on a touch screen 210 of the mobile device 100 with the index finger and then locates the index finger to the fingerprint sensor 220, the mobile device 100 recognizes the gesture and the biometric information, the content A, and a store command corresponding to the recognized gesture and the recognized biometric information. The mobile device 100 executes the store command to perform the action to store the content A in a storage space which is allocated to the user A of a cloud server.

Further, referring to FIG. 2B, when a user B makes a drag-in gesture which drags the index finger to an arbitrary point on the touch screen 210 from the fingerprint sensor 220 after locating the index finger on the fingerprint sensor 220 of the mobile device 100, the mobile device 100 recognizes the gesture and the biometric information, content B, and an import command corresponding to the recognized gesture and the recognized biometric information. The mobile device 100 executes the import command to perform the action to import the content B in a storage space which is allocated to the user B of a cloud server.

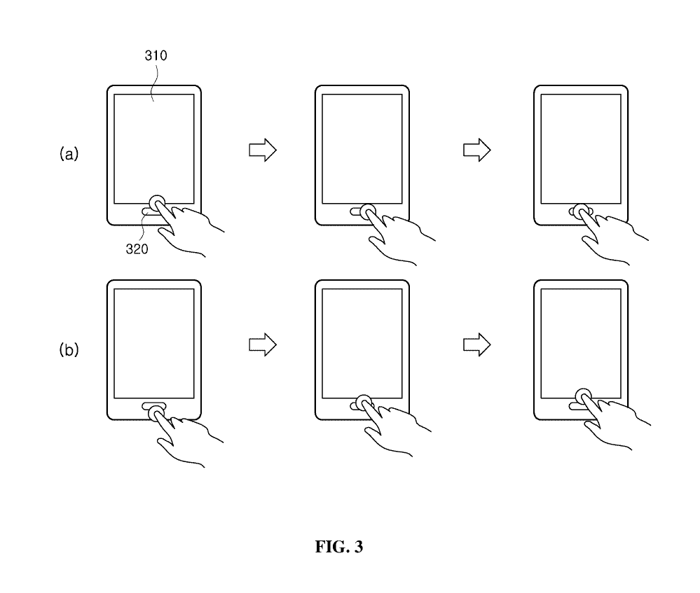

Further, referring to FIG. 3A, when the user A moves the index finger from top to bottom while locating the index finger on a fingerprint sensor 320 of the mobile device 100, the mobile device 100 recognizes the gesture and the biometric information, the content A, and a store command corresponding to the recognized gesture and the recognized biometric information. The mobile device 100 executes the store command to perform the action to store the content A corresponding to the index finger of the user A in the storage space which is allocated to the user A in the cloud server.

Further, referring to FIG. 3B, when the user B moves the index finger from bottom to top while locating the index finger on the fingerprint sensor 320 of the mobile device 100, the mobile device 100 recognizes the gesture and the biometric information, the content B, and the import command corresponding to the recognized gesture and the recognized biometric information. The mobile device 100 executes the import command to perform the action to import the content B which is stored to correspond to the index finger of the user B in the storage space which is allocated to the user B in the cloud server to the mobile device 100.

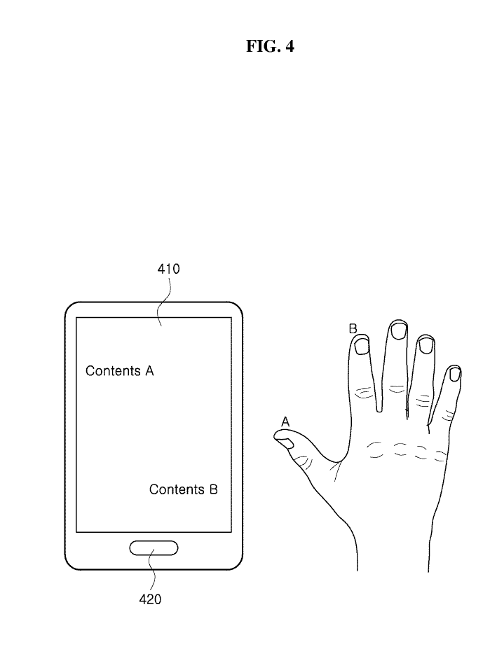

Further, referring to FIG. 4, when the user A touches the content A displayed on a touch screen 410 with the index finger for a predetermined time and touches the content B with the thumb for a predetermined time, the index finger and the thumb of the user A correspond to the content A and the content B respectively. Continuously, referring to the FIG. 4, when the user A inputs a predetermined gesture using the index finger, a predetermined command is executed on the content A corresponding to the index finger and when the user A inputs a predetermined gesture using the thumb, a predetermined command is executed on the content B corresponding to the thumb.

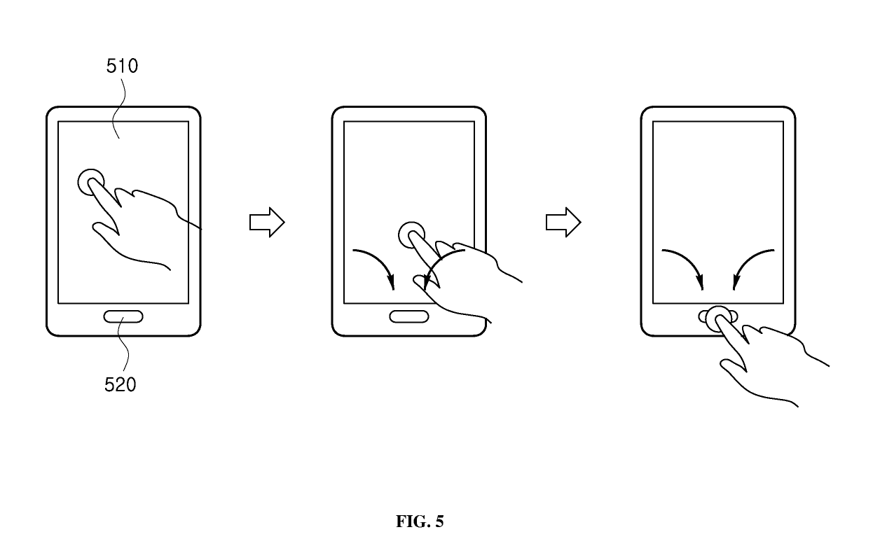

FIG. 5 shows example illustrations illustrating a process of providing a visual feedback, according to an embodiment as disclosed herein. In an embodiment, when the user touches a specific object displayed on a touch screen 510 of the mobile device 100, an arrow-shaped visual feedback which leads the user to input the gesture corresponding to “drag” described above is displayed on the touch screen 510.

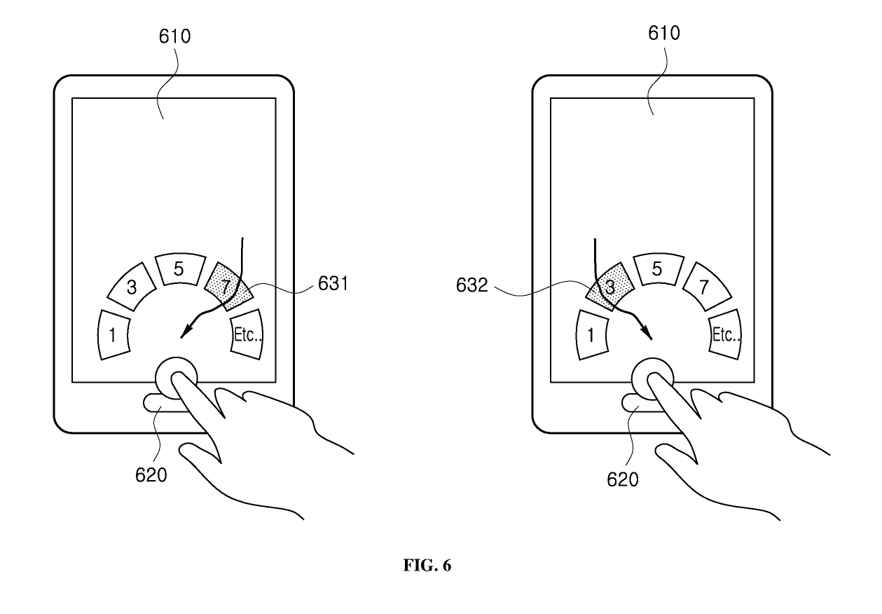

FIG. 6 shows example illustrations illustrating operations of the user interface, according to an embodiment as disclosed herein. In an embodiment, when the user makes the drag gesture by dragging the index finger toward a fingerprint sensor 620 of the mobile device 100 (via a specific region 631 or 632 of a plurality of regions displayed on a touch screen 610) while touching the arbitrary region on the touch screen 610 of the mobile device 100 with the index finger, and then locates the index finger on the fingerprint sensor 620, the mobile device 100 recognizes the gesture and the biometric information, and a command corresponding to the specific region. For example, when the drag gesture passes through a block 631 represented by number “7”, the payment is made on a seven month installment plan (see FIG. 6A) and when the drag gesture passes through a block 632 represented by number “3”, the payment is made on a three month installment plan (see FIG. 6B).

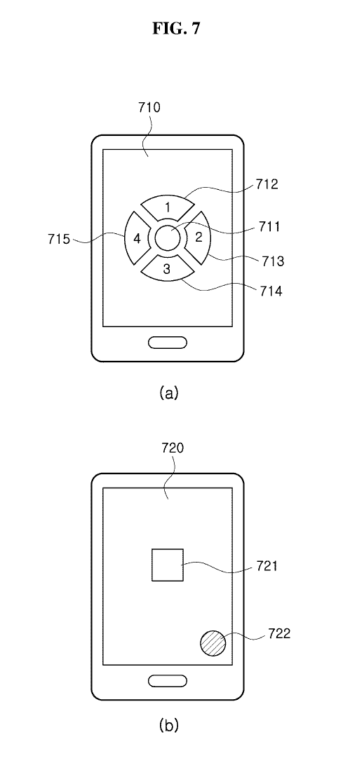

FIG. 7 shows example illustrations illustrating a configuration which provides the user interface using the integrated technical unit, according to an embodiment as disclosed herein.

Referring to FIG. 7A, when the user performs a manipulation to touch a first graphic element 711 on a fingerprint recognizing an integrated touch screen 710, information on a position where the touch manipulation is performed and fingerprint information of the user are obtained. When the user performs a manipulation (for example, a dragging manipulation) to move the touch to second graphic elements 712 to 715 on the fingerprint recognizing integrated touch screen 710 (on an assumption that the user has a necessary right), a command corresponding to the second graphic elements 712 to 715 may be performed on an object corresponding to the first graphic element 711. The command is executed to perform the action such as send the file, delete the file, share the file, store the file in the cloud, execute the application, or the like.

Further, referring to FIG. 7B, only when the user touches a specific region (hereafter, referred as a fingerprint recognizing region) on the fingerprint recognizing integrated touch screen 720, the fingerprint information may be obtained. That is, it is determined whether to activate a fingerprint recognizing function depending on a region of the fingerprint recognizing integrated touch screen 720 where the touch manipulation is input.

Continuously, referring to FIG. 7B, when the user performs a manipulation to touch the first graphic element 721 on the fingerprint recognizing integrated touch screen 720, information on a position where the performed touch manipulation is obtained. When the user performs a manipulation (for example, a dragging manipulation) to move the touch to the fingerprint recognizing region 722, the fingerprint information of the user is obtained only through the fingerprint recognizing region 722. Further, on an assumption that the user has a necessary right, a command (for example, send a file, delete a file, share a file, store a file in a cloud, or execute an application) corresponding to the first graphic element 721 or the fingerprint recognizing region 722 is determined and executed on the object corresponding to the first graphic element 721 or the fingerprint recognizing region 722.

Hereinafter, various example embodiments which may be introduced together with the FIG. 7 will be described.

In an embodiment, in a state when the user performs a manipulation to touch the first graphic element on the fingerprint recognizing integrated touch screen 720 but the touch manipulation is not released (that is, in a state when the user continuously touches the fingerprint recognizing integrated touch screen), and the touch moves to a fingerprint recognizing region in which a fingerprint recognizing function is performed, the fingerprint information of the user may be obtained through the fingerprint recognizing region.

In an embodiment, the fingerprint recognizing region where the fingerprint recognizing function is performed on the fingerprint recognizing integrated touch screen 720 may be temporarily displayed based on the touch manipulation of the user.

As an example, only when the user inputs a touch manipulation corresponding to the gesture which is set in advance on the fingerprint recognizing integrated touch screen 720, the fingerprint recognizing region may be displayed on the fingerprint recognizing integrated touch screen 720.

In another example, only when the user touches a predetermined graphic element on the fingerprint recognizing integrated touch screen 720, the fingerprint recognizing region is displayed on the fingerprint recognizing integrated touch screen 720. In contrast, only when the user touches the fingerprint recognizing region 722 on the fingerprint recognizing integrated touch screen 720, the predetermined graphic element may be displayed on the fingerprint recognizing integrated touch screen 720.

In still another example, the fingerprint recognizing region 722 is displayed on the fingerprint recognizing integrated touch screen 720 only while the user maintains the touch state for a predetermined graphic element on the fingerprint recognizing integrated touch screen 720 and when the user releases the touch state, the fingerprint recognizing region 722 which is displayed on the fingerprint recognizing integrated touch screen 720 disappears.

Further, in an embodiment, a displayed size, a displayed type, a displayed color, a displaying method, and a displaying time of the fingerprint recognizing region 722 may vary depending on the graphic element which is touched by the user on the fingerprint recognizing integrated touch screen 720 or a type or a function of the object corresponding to the graphic element.

In an embodiment, corresponding to the touch of the user on a predetermined graphic element displayed on the fingerprint recognizing integrated touch screen 720, auditory feedback or tactile feedback is also provided. In this case, intensity, a cycle (frequency), a pattern, or a providing method of the auditory feedback or the tactile feedback may vary depending on the touched graphic element, a type, or a function of the object corresponding to the graphic element.

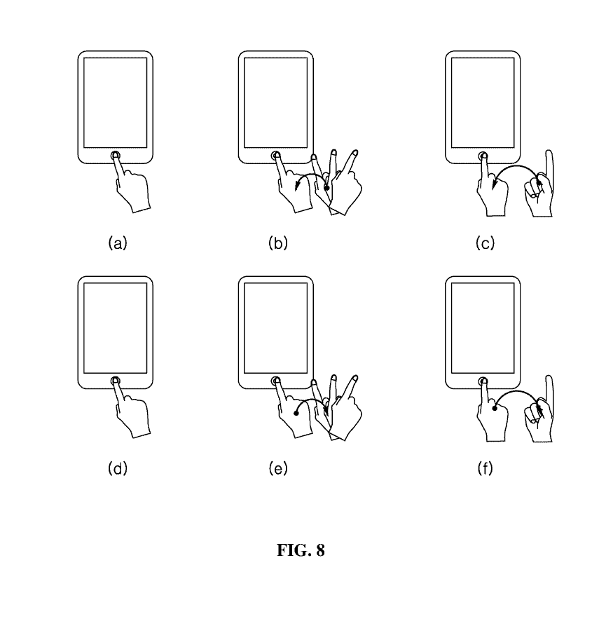

FIG. 8 is shows example illustrations illustrating a configuration in which various commands are performed in accordance with various gestures, according to an embodiment as disclosed herein.

In an embodiment, the user may execute various commands by inputting biometric information (that is, fingerprint information) after making various gestures or making various gestures after inputting the biometric information. Specifically, it is assumed that the user directly touches the fingerprint sensor to input fingerprint information without making any gestures (see FIG. 8A), or the user touches the fingerprint sensor to input the fingerprint information after making a gesture which shakes hands in the air (see FIG. 8B), or the user touches the fingerprint sensor to input the fingerprint information after making the gesture which turns the hand over (see FIG. 8C) and different commands corresponding to three cases may be executed. Further, it is assumed that the user directly touches the fingerprint sensor to input fingerprint information without making any gestures (see FIG. 8D), or the user makes the gesture which shakes hands in the air after touching the fingerprint sensor to input the fingerprint information (see FIG. 8E), or the user makes the gesture which turns the hand over after touching the fingerprint sensor to input the fingerprint information (see FIG. 8F) and different commands corresponding to three cases may be executed.

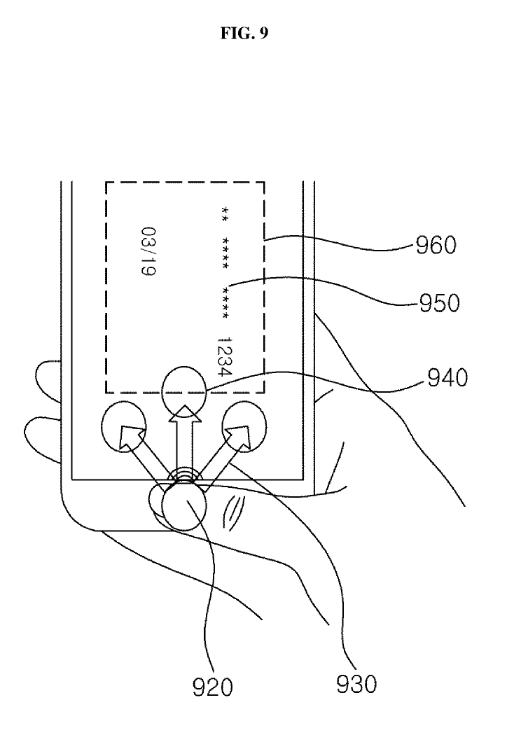

FIGS. 9 to 11 shows example illustrations illustrating a payment process using the mobile device 100, according to an embodiment as disclosed herein.

Referring to the FIG. 9, the mobile device 100 includes a biometric information unit 920 and a graphic element 950. In an embodiment, the biometric information unit 920 is a fingerprint sensor which recognizes a fingerprint. The graphic element 950 includes a credit card image or a coupon/membership point card image, for example.

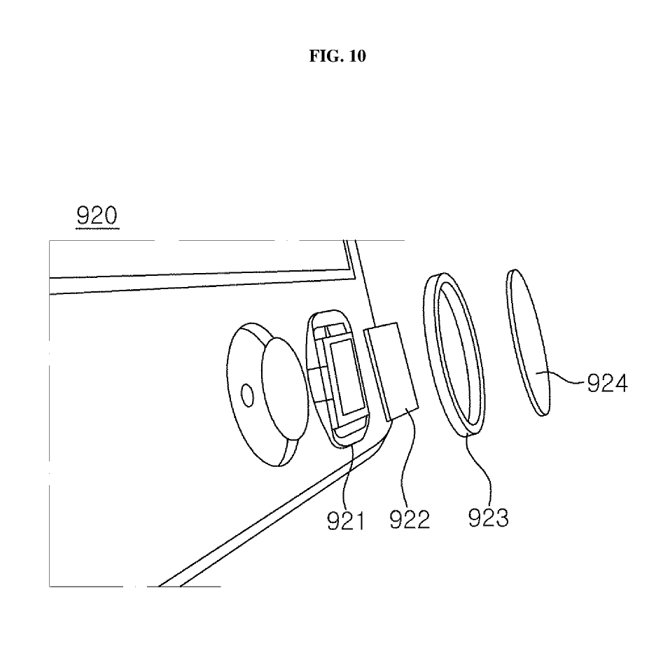

FIG. 10 is a diagram illustrating a high level overview of a general fingerprint sensor, accordingly to an embodiment as disclosed herein. In an embodiment, the operation of the mobile device 100 of the FIG. 9 is described in detail in conjunction with the FIG. 10. Referring to the FIG. 10, the biometric unit 920 is, for example, a fingerprint sensor including a lens unit 924, a touch detecting ring 923, an adhesive layer 922, and a sensor unit 921. The lens unit 924 functions as a lens which protects the sensor unit 921 and precisely focuses a finger. The touch detecting ring 923 detects whether the finger touches the biometric information recognizing unit 920. The sensor unit 921 detects a change in capacitance of the sensor in accordance with unevenness of a surface of the finger to detect feature points of the fingerprint. Further, a direction of the fingerprint and motions of the fingers may be detected using positions of the feature points of the fingerprint.

Hereinafter, a payment method according to an exemplary embodiment of the present invention will be described with reference to the FIGS. 9 to 11.

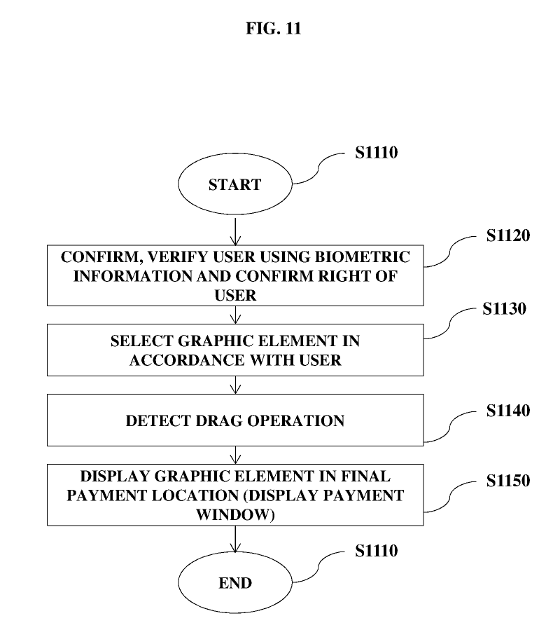

Referring to the FIG. 11, the payment process starts through the mobile 100 in step S1110. The payment process starts when a related payment application program is executed, a user terminal including the mobile device 100 enters a specific location where payment is requested, or a POS terminal which requires payment is detected nearby, or an application is driven through a near field communication (NFC). Whether to enter a specific location may be known through a GPS system mounted in the user terminal or a position information system using beacon.

After starting the payment process, the mobile device 100 confirms and verifies a user who touches using biometric information detected by the biometric unit 920 and confirms a right of the user.

Further, the mobile device 100 selects a graphic element 950 in accordance with the user which is confirmed through the biometric information recognizing unit 920. Desirably, the user selects a registered graphic element 950. When there is a plurality of registered graphic elements 950, the user selects any one of the plurality of graphic elements 950.

For example, the user may select the graphic element 950 in accordance with an order of priority designated by the user, select the graphic element 950 which is the latest used by the user based on usage history information, select a most frequently used graphic element 950, select the graphic element 950 by referring to a usage history for every category (for example, a gas bill, eating-out expense, or shopping), select the graphic element 950 which is registered by the user by referring to position information, or select the graphic element by referring to a location marked on a calendar (appointment information of the user).

The mobile device 100 makes the graphic element 950 selecting method as a profile to store the profile. For example, the profile may include a usage history of the graphic element 950, a usage history for every payment type (for example, a gas bill, eating-out expense, or shopping cost), or a discount rate for every business/business type or card. A profile storage location may be a memory of the mobile device 100 or a separate server. When the profile is stored in the separate server, the graphic element 950 may be selected through a network.

A card which is the most suitable at the payment time may be automatically and conveniently recommended to the user through the graphic element 950 selecting method exemplified in the exemplary embodiment.

Alternatively, as illustrated in the FIG. 9, the graphic element 950 may be selected in accordance with the direction of the drag 930. In this case, as described in the exemplary embodiment of the FIG. 6 or 7, the graphic element 950 in accordance with the direction of the drag 930. For example, a separate graphic element representing a recommended card may be added.

Further, the mobile device 100 detects the gesture of the user, for example, an operation of the drag 930 and displays the selected graphic element 950. In this case, an animation effect showing that the graphic element 950 moves in accordance with the operation of the drag 930 may be added.

In this case, the mobile device 100 monitors whether the drag 930 operation is continuously performed, that is, the user touch is released in the middle of the operation until the graphic element 950 is displayed in a final payment available location 960 on the touch screen since the biometric information unit 920 is touched.

For example, when the fingerprint sensor is located at a boundary of the display, whether the touch is maintained is monitored through the touch detecting ring 923 and the touch screen 210. In this case, the mobile device 100 recognizes whether to start the drag 930 operation by recognizing a position change of the feature points by the biometric information recognizing unit 920 and confirms that the drag 930 operation is continuously performed through the above monitoring.

Alternatively, when a touch on the touch screen is detected within a predetermined time after the touch is released from the biometric information recognizing unit 920, it is considered that the drag 930 operation is continuously performed.

When the touch screen and the fingerprint sensor are integrated with the display, the touch state from the activated fingerprint recognizing region is continuously maintained, so that whether the drag 930 operation is continuously performed may be confirmed.

When the drag 930 operation is completed, the graphic element 950, for example, the credit card image is displayed in a final payment available location 960. In this case, a payment window which inquires whether the user makes a payment may be additionally displayed. The window may include final payment information (for example, a purchased item, price, or selected card information) and a payment confirmation button. In the FIG. 9, the final payment available location 960 is represented by a dotted line, but the dotted line of the final payment available location 960 may not be displayed in an actual situation.

A payment method of the related art is formed of operations including two steps of selecting a payment card and touching a separate fingerprint sensor. In contrast, according to the exemplary embodiment, the payment card is selected and the fingerprint sensor is touched simultaneously through one step, so that the user may be provided with a convenience and intuitive user interface. Further, the card is recommended by utilizing a context (a location, a preference card, or a card which provides a highest discount rate for every category) of the user, so that the user may conveniently use the most appropriate and favorable card without making an effort to select a card.

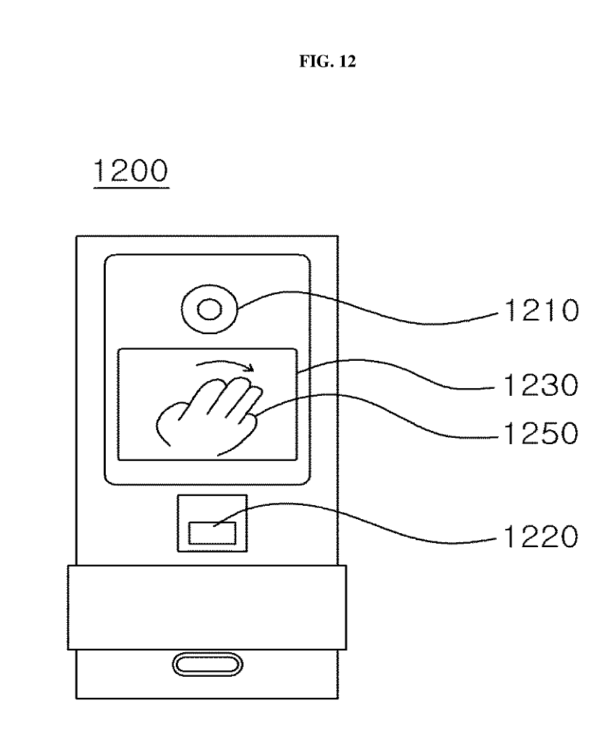

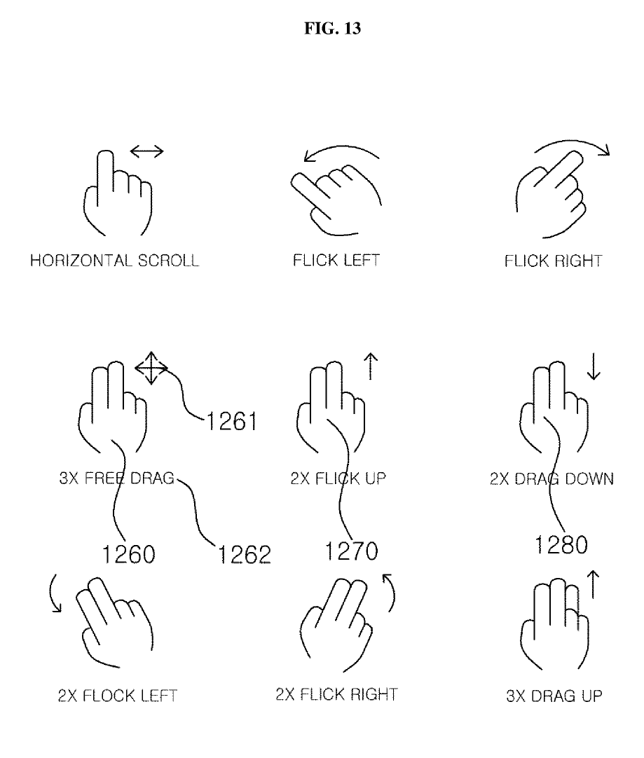

FIGS. 12 and 13 show example illustrations of the multi-modal security system 1200 which utilizes the gesture and fingerprint recognition, according to an embodiment as disclosed herein.

In an embodiment, an example implementation of a method for strengthening security to prepare for a possibility of illegally obtaining a fingerprint or fingerprint information. Referring to the FIG. 12, the multi-modal security system 1200 includes a camera 1210, a biometric information recognizing unit 1220, and a display 1230. The multi-modal security system 1200 may further include a graphic element 1250. The multi-modal security system 1200 may be implemented as a portable terminal which includes a camera and a biometric information recognizing unit and may be a terminal which is provided near an entrance to control entry.

The multi-modal security system 1200 first displays a request to input a gesture through the camera 1210 on the display 1230.

FIG. 13 illustrates an example of gestures 1260, 1270, and 1280 recognizable by the multi-modal security system 1200. When a predetermined single gesture is input to the camera or a combination of a plurality of gestures 1260, 1270, and 1280 is input as a cipher, the multi-modal security system 1200 activates the biometric information recognizing unit 1220. The combination may be formed by inputting the plurality of gestures according to an order or by inputting predetermined gestures without having an order.

The multi-modal security system 1200 completes a second verifying step by receiving the biometric information of the user such as a fingerprint through the biometric information recognizing unit 1220 after completing a first verifying step of the user including a gesture input step.

In contrast, the multi-modal security system 1200 may request to input the gesture through the camera 1210 after verifying the user in the first step through the biometric information recognizing unit 1220.

When a predetermined gesture is input, the multi-modal security system 1200 feedbacks the graphic element 1250 which is recognized by the multi-modal security system 1200 through the display 1230 to assist the user in inputting a gesture.

Auxiliary graphic elements which allow the user to easily recognize feedback, for example, include any one of a symbol 1261 representing a recognized gesture and gesture content 1262.

Alternatively, only the gesture symbol 1261 or the gesture content 1262 which are auxiliary graphic elements may be displayed on an actual screen.

The multi-modal security system 1200 may increase the number of gestures to be input in accordance with an importance of transaction, for example, a payment amount or a security level. For example, in a location where security is important, the multi-modal security system 1200 sets different security levels to rooms and requests to input more gestures for a room having a higher security level. Alternatively, the multi-modal security system 1200 may request to input more gestures when the payment amount is larger than a predetermined amount.

When the two steps of security processes are completed, a necessary operation (for example, open the entrance or proceed a payment process, or execute an application) is performed.

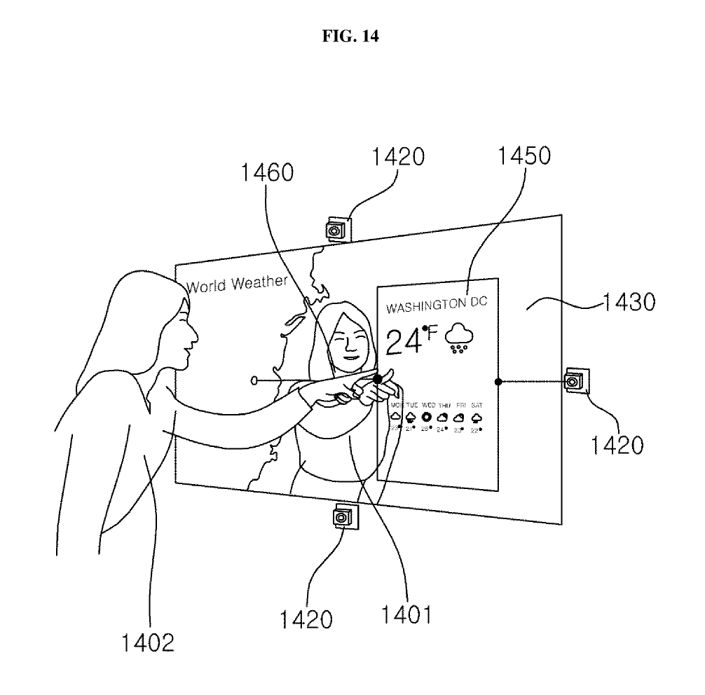

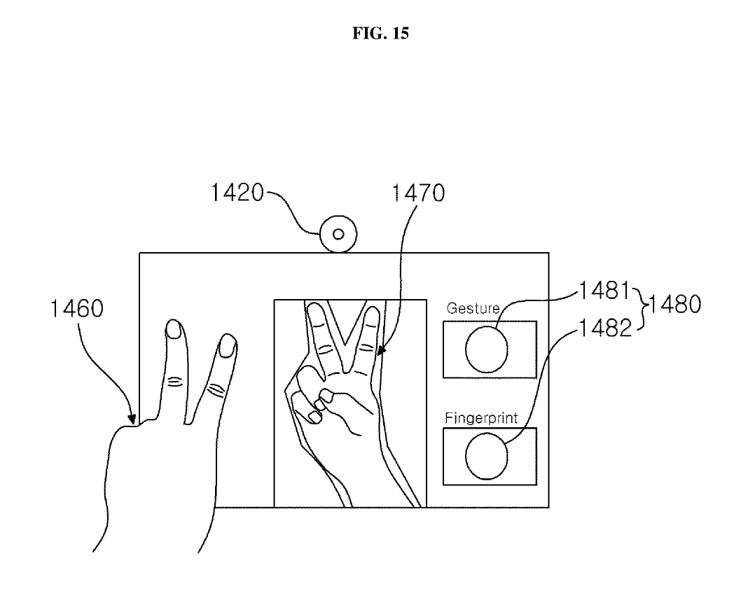

FIGS. 14 and 15 illustrate the mobile device 100 which is implemented in a display 1430 with a camera function, according to an embodiment as disclosed herein. Referring to the FIG. 14, the display 1430 with the camera function provides a screen which is required for the verified user 1401.

Here, the display 1430 with a camera function includes all the devices which include the display 1430 and a camera 1420 such as a display such as a television, a mirror display, a personal computer, a tablet, a phablet to display the screen and also capture an image. For example, in the case of the mirror display with a camera function, the user 1401 watches their own image 1402 and also watches the graphic element 1450 which displays the desired information.

In the exemplary embodiment, when the user 1401 makes a predetermined gesture 1460, the display 1430 with the camera function analyzes an image photographed through the camera 1420 to recognize the fingerprint of the user. The camera 1420 needs to process a sufficiently high resolution image so as to recognize the fingerprint. Further, a plurality of cameras 1420 may be provided to control through various gestures 1460. When a plurality of cameras 1420 is provided, fingerprint images which are photographed by the cameras 1420 are analyzed to use a fingerprint which is photographed through a camera to provide the best recognition result for verifying the user.

In this case, a screen which leads a predetermined gesture 1460 may be displayed on the display 1430 with the camera function. When the gesture 1460 is set in advance, the user is instructed to make the gesture which is advantageous to recognize the fingerprint if possible. When the user registers a gesture through which the fingerprint is not recognized, an error message may be displayed.

Further, the gesture 1460 which is set in advance may indicate different gesture in some cases. For example, the display 1430 with the camera function is set to couple the gesture which makes a character V with fingers with a command to access specific content and set to couple an overall power on/off operation of the display 1430 with a thumb-up gesture. In this case, when the above-described specific gesture is made, the display 1430 is set to recognize the fingerprint through the camera 1420 and perform the coupled operation for the verified user.

According to an exemplary embodiment of the present invention, when the gesture or the fingerprint is captured, a preview may be provided. For example, referring to FIG. 15, an actual screen of a guide line 1470 which leads the gesture and a hand of the user 1460 is displayed on a display device with a camera function. Further, a verifying state display 1480 which displays a present verifying situation is also displayed. The verifying state display includes a gesture state display 1481 which displays whether to match a pre-stored gesture and a fingerprint state display 1482 which displays whether the fingerprint is verified.

Alternatively, simultaneous verification may be performed to allow a plurality of persons which is in front of the display 1430 with the camera function to pay a predetermined amount. For example, when person A and person B order a chicken in front of a TV, if person A and person B make the same predetermined gesture at the same time, the fingerprints of person A and person B are obtained from the camera 1420 to make a payment at a predetermined rate or by a predetermined amount from a predetermined bank account.

When the user is verified, predetermined graphic elements 1450 according to the verified user are illustrated. The setting may be stored in a memory of the display 1430 or stored through the network. When the payment is completed, the graphic element 1450 may be a screen showing that the payment is completed. When the user accesses specific screen or content, the graphic elements 1450 may be the specific screens. Alternatively, when a plurality of users is verified, the predetermined graphic element 1450 may be an image which is stored in advance and represents the verified person.

More specifically, the graphic element 1450 may illustrate different content depending on a right which is empowered to the verified user. For example, the user A may be set to make a payment, read a confidential document, or transmit a file through the mirror display 1430 and the user B may be set to only read a simple document.

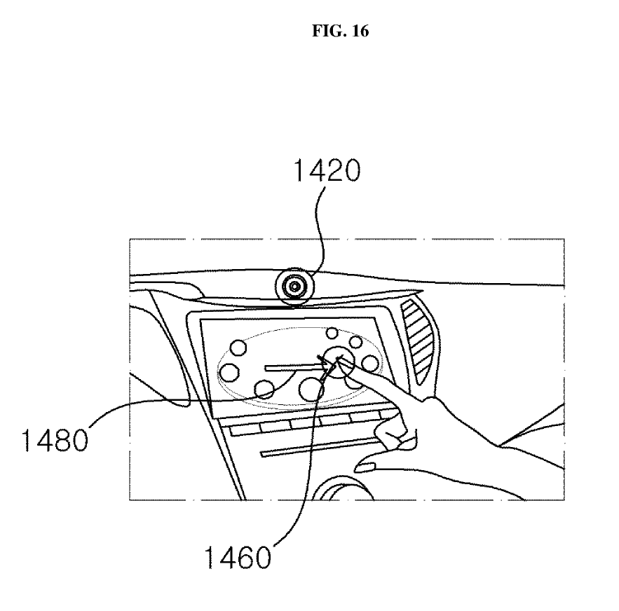

FIG. 16 is a view illustrating another exemplary embodiment of a display 1430 with a camera function which is mounted on a vehicle, according to an embodiment as disclosed herein. The FIG. 16 is basically similar to an exemplary embodiment of the display 1430 with a camera function of FIGS. 14 and 15. Hereinafter, features which are not illustrated in FIGS. 14 and 15 will be mainly described.

In the FIG. 16, the gesture of the hand of the user 1460 may be detected on the display 1430 with the camera function, without directly touching the screen with the hand of the user 1460. The gesture of the hand may be detected by analyzing an image obtained through the camera 1420 in the display 1430 device with the camera function. Alternatively, the touch screen panel in the display 1430 with the camera function may sense and detect hovering, that is, movement of the hand without touching the touch screen panel. Those skilled in the art may implement the exemplary embodiment using an appropriate hovering detecting unit.

When the user 1460 is in a driver's seat or an assistant driver's seat for the first time, the user 1460 may register a fingerprint through the camera 1420. After registering the fingerprint, when the display 1430 with the camera function detects a hovering gesture through the camera 1420 or the touch screen panel, the image is analyzed to confirm an identity of the user 1460. That is, it is confirmed whether the person is a driver who sits in a driver's seat or an assistant driver who sits in an assistant driver's seat.

It may be dangerous when the driver directly manipulates the display 1430, so that after determining whether the present situation is a driving situation or a stop situation, the display 1430 with the camera function may restrict the manipulation of the screen by the driver. For example, the display 1430 with the camera function may be set such that the driver performs only a necessary manipulation, for example, at least a necessary function such as enlargement of the navigation. Alternatively, the driver may be restricted so as not to manipulate the display while driving a car. However, manipulation of the display 1430 with the camera function by the assistant driver is less related with the safety, so that the assistant driver may perform all the manipulations regardless of the driving situation. Alternatively, there may be minimum limitations so as not to control an element which disrupts the driving such as a moving image so that the driver does not pay attention thereto while driving the car.

In the hovering situation, since it is not clear which one is the user's gesture, a mark UI 1480 representing the gesture may be provided. When a fingertip of the user 1460 stops at a specific location, the mark UI 1480 may represent the location of the user, similarly to a cursor.

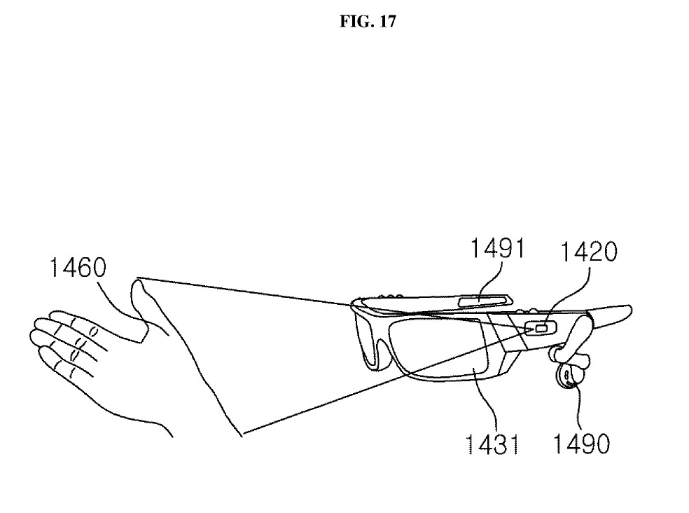

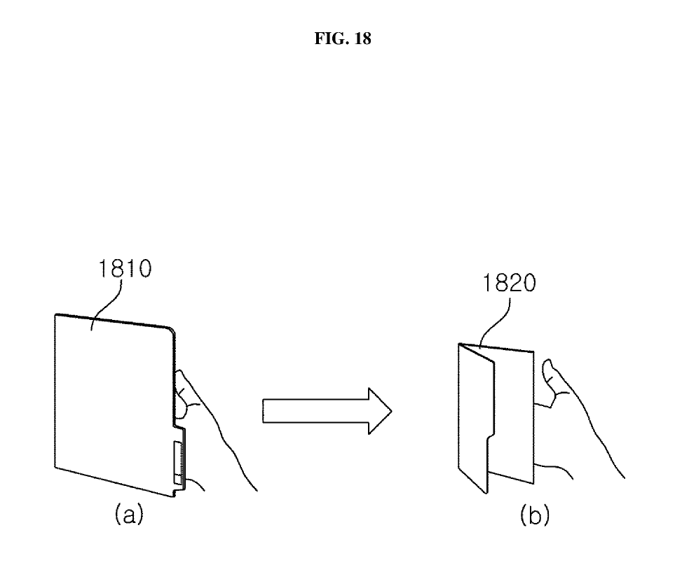

FIGS. 17 and 18 show example illustrations illustrating another display 1430 with the camera function implemented by a Head Mounted Display (HMD), according to an embodiment as disclosed herein. The display 1430 with the camera function illustrated in the FIG. 17 is basically similar to an exemplary embodiment of the display 1430 with the camera function of the FIGS. 14 and 15. Hereinafter, features which are not illustrated in FIGS. 14 and 15 will be mainly described.

The display 1430 with the camera function includes a see-through display 1431, a camera 1420, and an earphone/microphone 1490. Selectively, the display 1430 may include a proximity sensor which continuously monitors a wearing state.

The see-through display 1431 may be implemented as a transparent display to see the situation of the outside or display an external situation which is photographed through the camera 1420 even though the display is not transparent.

When the user 1460 wears the display 1430 with the camera function, the camera 1420 photographs an image with the eyes which are the same as the user. Further, the camera 1420 is configured such that a graphic image is composited with an image obtained through photographing to implement augmented reality. The graphic image may include, for example, folder images 1810 and 1820.

As illustrated in FIG. 18A, when the display 1430 with the camera function detects a gesture of a user 1460 who picks up a folder 1810 through the camera 1420, the display 1430 recognizes the fingerprint through the camera 1420. Alternatively, the user may be verified through a voice which is recognized through the earphone/microphone 1490. Alternatively, after the first verification using biometric information such as fingerprint verification through the camera 1420 and voice verification through the earphone/microphone 1490, it is continuously monitored that the user 1460 wears the display 1430 with the camera function through the proximity sensor 1491 to verify the user. Those skilled in the art may understand that the devices exemplified in the present invention may verify the user using appropriate biometric information.

When a person whose fingerprint is recognized to verify that a person who has a right to read the folder manipulates the display 1430 with the camera function, as illustrated in the FIG. 18B, the folder 1820 is open to be accessed.

Even though an embodiment which manipulates the folder has been described, when a palm faces the camera of an HMD device to photograph a fingerprint or any gesture is applicable. For example, when a gesture which picks up a specific item is detected through a camera, the gesture is coupled to verification through the biometric information and the graphic is composited with an image which is photographed to be watched through the display 1431. For example, such embodiment may be applicable to a pick-up gesture through various methods such as a gesture which picks up a coin or paper bill, a gesture which picks up goods.

In an embodiment, a picking-up motion is detectable through image analysis. For example, when a plurality of cameras 1420 is provided, an area of a palm of the user 1460 is calculated and the area of the palm is reduced to a predetermined size or less, it is determined that the motion is the picking-up motion.

Alternatively, when it is determined that a distance between lines of the palm of the user 1460 is reduced through the image analysis, it is determined that the motion is the picking-up motion.

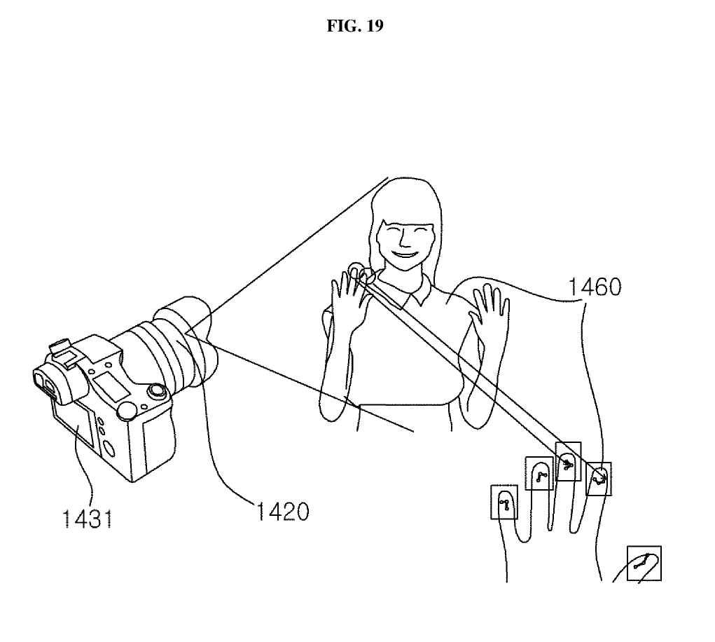

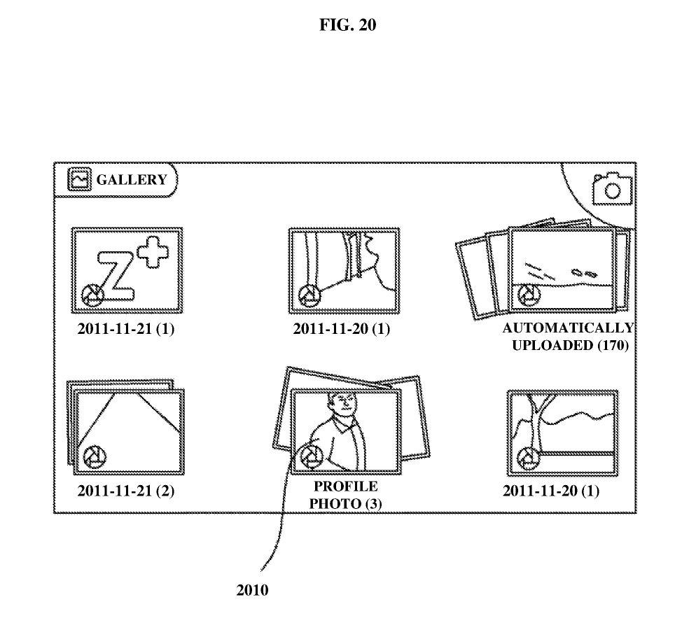

FIGS. 19 and 20 show example illustrations illustrating yet another display 1430 with the camera function, according to an embodiment as disclosed herein. The display 1430 with the camera function illustrated in the FIGS. 19 and 20 are basically similar to the exemplary embodiment of the display 1430 with the camera function of the FIGS. 14 and 15. Hereinafter, features which are not illustrated in the FIGS. 14 and 15 will be mainly described.

Referring to the FIG. 19, the display 1430 with the camera function monitors whether the user 1460 makes a gesture (pose) which shows a palm or a fingerprint. At the time of photograph, when it is detected that the user makes a gesture which shows the palm or the fingerprint, the fingerprint is recognized. Further, it is determined whether a photographing object is a person which is already registered through the recognized fingerprint.

FIG. 20 illustrates an exemplary embodiment of a photo gallery. The photo gallery may be stored in a storage 2010 which is a specific folder in a memory in the display 1430 with the camera function or stored in the storage 2010 which has a specific uniform resource locator on a network. An owner of the storage 2010 is basically a user who is a photographing object and the storage 2010 may access the owner of the storage 2010 or a person who is permitted by the owner of the storage 2010.

After photographing the person, a message is sent to a contact corresponding to the recognized fingerprint through a communication device (not illustrated) in the display 1430 with the camera function to notify that the person is photographed and the fingerprint information is utilized.

A photo which is photographed through the display 1430 with the camera function may be stored in the storage 2010.

According to the exemplary embodiment, the photographed moving images or photos may be automatically arranged and stored in a specific lower folder in the storage 2010. When the user 1460 sets in advance, the images or photos may be stored in a specific lower folder of the storage 2010 using context information figured out through other sensors in the display 1430 with the camera function. For example, a GPS or a sensor of a skin temperature of the photographing object. The context information may include, for example, a photographed location or emotion of the photographing object figured out using a skin temperature of the photographing object.

According to an embodiment, when the user 1460 sets specific context information in advance to store a photo photographed and when the photographing object feels good in a specific location in a specific folder in the storage described above, the recognized fingerprint is utilized to store the photo in the specific folder.

The embodiment described above may be implemented in the form of a program command which may be executed through various computer components to be recorded in a non-transitory computer readable recording medium. The program commands recorded in the non-transitory computer readable recording medium may be specifically designed or constructed for the present invention. Examples of the non-transitory computer readable recording medium include magnetic media such as a hard disk, a floppy disk, or a magnetic tape, optical recording media such as a CD-ROM or a DVD, magneto-optical media such as a floptical disk, and a hardware device which is specifically configured to store and execute the program command such as a ROM, a RAM, and a flash memory.

The present invention is not limited to the above specific preferred example embodiments, the example embodiments may be variously modified by those skilled in the art to which the present invention pertains without departing from the subject matters of the present invention claimed in the claims, and the modifications belong to the scope disclosed in the claims.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the technical spirit and scope of the embodiments as described herein.

What is claimed is:

1. A mobile device for automatically performing an action, the mobile device comprising:
a gesture unit configured to recognize a gesture performed by a user on an object displayed on the mobile device;
a biometric unit configured to recognize a biometric information based on the gesture;
a command unit configured to determine a command corresponding to the gesture and the biometric information; and
a control unit configured to perform an action on the object based on the command.

2. The mobile device of claim 1, wherein the gesture is at least one of a single-touch gesture, a multi-touch gesture, a posture gesture, a motion gesture, and a hover gesture.

3. The mobile device of claim 1, wherein the biometric information is at least one of fingerprint information, vein information, iris information, voice information, pulse information, brain wave information, temperature information, blood pressure information, skin color information, and respiration information.

4. The mobile device of claim 1, wherein the action comprises at least one of trigger a payment with a credit card, store content in a storage space, import content, send content, delete content, share content, open an application, close an application, lock an application, modify an access level, and modify a security level.

5. The mobile device of claim 1, wherein the action is performed based on a right empowered to a user.

6. The mobile device of claim 1, wherein the command, corresponding to the biometric information, is predefined and stored in the mobile device.

7. The mobile device of claim 1, wherein the command, corresponding to the biometric information, is dynamically defined based on the gesture.

8. The mobile device of claim 1, wherein the user is identified based on the biometric information.

9. The mobile device of claim 1, wherein the object corresponds to a graphical element displayed on the mobile device, wherein the gesture recognition unit activates a gesture recognition function in the graphical element.

10. A computer implemented method for automatically performing an action in a mobile device, the method comprising:
recognizing, by a gesture unit, a gesture performed by a user on an object displayed on the mobile device;
recognizing, by a biometric unit, a biometric information based on the gesture;
determining, by a command unit, a command corresponding to the gesture and the biometric information; and
performing, by a control unit, an action on the object based on the command.

11. The method of claim 10, wherein the gesture is at least one of a single-touch gesture, a multi-touch gesture, a posture gesture, a motion gesture, and a hover gesture.

12. The method of claim 10, wherein the biometric information is at least one of fingerprint information, vein information, iris information, voice information, pulse information, brain wave information, temperature information, blood pressure information, skin color information, and respiration information.

13. The method of claim 10, wherein the action comprises at least one of trigger a payment with a credit card, store content in a storage space, import content, send content, delete content, share content, open an application, close an application, lock an application, modify an access level, and modify a security level.

14. The method of claim 10, wherein the action is performed based on a right empowered to a user.

15. The method of claim 10, wherein the command, corresponding to the biometric information, is predefined and stored in the mobile device.

16. The method of claim 10, wherein the command, corresponding to the biometric information, is dynamically defined based on the gesture.

17. The method of claim 10, wherein the user is identified based on the biometric information.

18. The method of claim 10, wherein the object corresponds to a graphical element displayed on the mobile device, wherein the gesture recognition unit activates a gesture recognition function in the graphical element.

19. A computer program product comprising a computer executable program code recorded on a computer readable non-transitory storage medium, wherein said computer executable program code when executed causing the actions comprising:
recognizing, by a gesture unit, a gesture performed on an object displayed on a mobile device;
recognizing, by a biometric unit, a biometric information based on the gesture;
determining, by a command unit, a command corresponding to the gesture and the biometric information; and
performing, by the command unit, an action on the object based on the command.
